(19) United States
(12) Patent Application Publication
(10) Pub. No.: US 2012/0313572 A1
(43) Pub. Date: Dec. 13, 2012

(54) INTEGRATED BUCK-BOOST CONVERTER OF CHARGING APPARATUS

(76) Inventor: Chang-Jyi SHEU, Taipei (TW)

(21) Appl. No.: 13/243,636

(22) Filed: Sep. 23, 2011

(30) Foreign Application Priority Data
Jun. 7, 2011 (TW) 100119795

(51) Int. Cl. H02J 7/00

(52) U.S. Cl. 320/107

(57) ABSTRACT

An integrated buck-boost converter of a charging apparatus receives a direct current (DC) input voltage and converts the voltage level of the DC input voltage to provide an output voltage for charging a rechargeable battery. The integrated buck-boost converter includes a first switch, a second switch, a first diode, a second diode, an inductor, and a capacitor. The integrated buck-boost converter can provide step-up and step-down conversion functions by controlling the first switch and the second switch, thus accurately providing the required voltage level of the charging voltage for charging the rechargeable battery, efficiently reducing the switching losses of the first switch and the second switch, and significantly increasing the overall efficiency of the integrated buck-boost converter.

### BACKGROUND OF THE INVENTION

1. Field of the Invention

The present invention relates generally to a buck-boost converter, and more particularly to an integrated buck-boost converter of a charging apparatus.

2. Description of Prior Art

For today's technologies of driving mobile vehicles, that will be developed toward the trend of pollution-free and high-efficiency purposes. The battery is usually used to store the desired energy for the electric vehicles. In particular, the various generated energies, such as coal-fire energy, hydraulic energy, wind energy, thermal energy, solar energy, and nuclear energy, have to be converted into the electrical energy so that the electrical energy can be stored in the battery. However, the major issues of security, efficiency, and convenience have to be concerned during the energy conversion process.

Reference is made to FIG. 1 which is a circuit block diagram of a prior art charging apparatus with a DC/DC converter. The charging apparatus 10A is applied to a mobile vehicle (not shown). The charging system of the mobile vehicle mainly includes the charging apparatus 10A and a rechargeable battery 20A. The mobile vehicle can be an electric vehicle or an electric motorcycle, and the rechargeable battery 20A is a rechargeable battery of the electric vehicle or the electric motorcycle.

The charging apparatus 10A includes an electromagnetic interference filter 102A, a power factor corrector 104A, and a DC/DC converter 106A. The electromagnetic interference filter 102A is electrically connected to an external AC power source Vs to eliminate noise in the AC power source Vs, thus preventing the conductive electromagnetic interference. The power factor corrector 104A is electrically connected to the electromagnetic interference filter 102A to improve the power factor of the power source. The DC/DC converter 106A is electrically connected to the power factor corrector 104A to provide required voltage levels.

When the rechargeable battery 20A needs to be charged, the external AC power source Vs may not meet to the required voltage level of the battery voltage Vb of the rechargeable battery 20A. Also, the battery voltage Vb of the rechargeable battery 20A is dynamically varied during charging process thereof. In order to obtain the required voltage level of the charging voltage for charging the rechargeable battery 20A, the DC/DC converter 106A usually has a two-stage circuit structure, namely, a combination of a boost converter and a buck converter. Reference is made to FIG. 2 which is a circuit diagram of a prior art two-stage DC/DC converter. The two-stage DC/DC converter 106A includes a boost converter 1062A and a buck converter 1064A. The boost converter 1062A is provided to step up the input voltage Vin; similarly, the buck converter 1064A is provided to step down the input voltage Vin. In this embodiment, the output voltage of the power factor corrector 104A is equal to the input voltage Vin of the two-stage DC/DC converter 106A. According to the relationship between the input voltage Vin and the battery voltage Vb, the boost converter 1062A or the buck converter 1064A is alternatively operated. That is, the buck converter 1064A is operated to step up the input voltage Vin when the input voltage Vin is greater than the battery voltage Vb; on the other hand, the boost converter 1062A is operated to step down the input voltage Vin when the input voltage Vin is smaller than the battery voltage Vb. Because the two-stage DC/DC converter 106A has both the boost converter and the buck converter, there are plenty of circuit components need to be used, thus increasing costs of the used components.

In addition, all switches of the buck-boost converter are simultaneously switched when one of the step-up operation or the step-down operation is executed. Hence, the prior art buck-boost converter is appropriately used for providing a low-power output because of the increasing switching losses and decreasing efficiency thereof.

Accordingly, it is desirable to provide an integrated buck-boost converter of a charging apparatus. The integrated buck-boost converter can accurately provide required voltage level of the output voltage for charging the rechargeable battery, thus efficiently reducing switching losses and significantly increasing conversion efficiency.

### SUMMARY OF THE INVENTION

An object of the invention is to provide an integrated buck-boost converter of a charging apparatus to solve the above-mentioned problems. The integrated buck-boost converter receives a DC input voltage and converts a voltage level of the DC input voltage to provide an output voltage for charging a rechargeable battery. The integrated buck-boost converter includes a first switch, a first diode, an inductor, a second switch, a second diode, and a capacitor.

The first switch has a first terminal and a second terminal. The first diode has an anode and a cathode, and the cathode of the first diode is electrically connected to the second terminal of the first switch. The inductor has a first terminal and a second terminal, and the first terminal of the inductor is electrically connected to the second terminal of the first switch and the cathode of the first diode. The second switch has a first terminal and a second terminal, and the first terminal of the second switch is electrically connected to the second terminal of the inductor. The second diode has an anode and a cathode, and the anode of the second diode is electrically connected to the second terminal of the inductor and the first terminal of the second switch. The capacitor has a first terminal and a second terminal, and the first terminal of the capacitor is electrically connected to the cathode of the second diode and the second terminal of capacitor is electrically connected to the second terminal of the second switch and the anode of the first diode.

The first terminal of the first switch and the anode of the first diode form a two-port input side of the integrated buck-boost converter for receiving the input voltage; and the first terminal of the capacitor and the second terminal of the capacitor form a two-port output side of the integrated buck-boost converter for outputting the output voltage to charge the rechargeable battery.

Therefore, the integrated buck-boost converter can provide both a step-up operation and a step-down operation by controlling the first switch and the second switch, thus accurately providing required voltage level of the output voltage for charging the rechargeable battery.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit block diagram of a prior art charging apparatus with a DC/DC converter;

FIG. 2 is a circuit diagram of a prior art two-stage DC/DC converter;

FIG. 3 is a circuit diagram of an integrated buck-boost converter of a charging apparatus according to the present invention;

FIG. 4A is a circuit diagram of the integrated buck-boost converter which is operated in a large-voltage-difference step-down operation;

FIG. 4B is a circuit diagram of the integrated buck-boost converter which is operated in a large-voltage-difference step-up operation;

FIG. 4C is a circuit diagram of the integrated buck-boost converter which is operated in a small-voltage-difference operation according to a first embodiment of the present invention;

FIG. 4D is a circuit diagram of the integrated buck-boost converter which is operated in a small-voltage-difference operation according to a second embodiment of the present invention; and

FIG. 4E is a circuit diagram of the integrated buck-boost converter which is operated in a small-voltage-difference operation according to a third embodiment of the present invention.

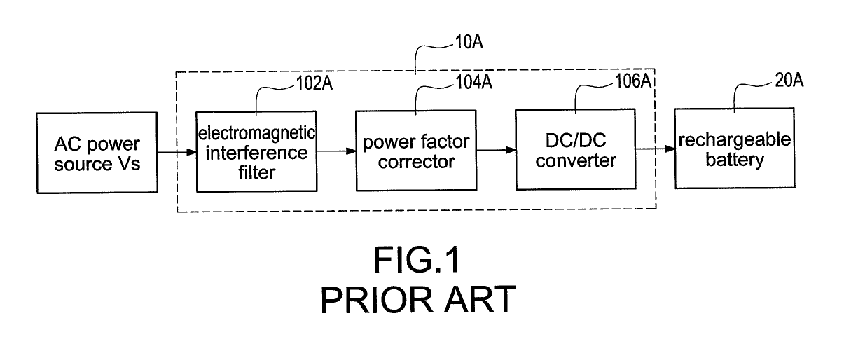

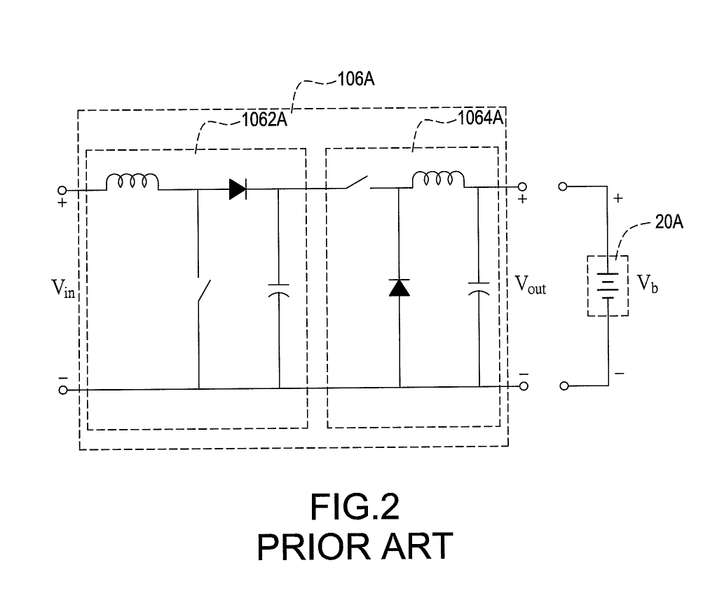

### DETAILED DESCRIPTION OF THE INVENTION

Reference will now be made to the drawing figures to describe the present invention in detail.

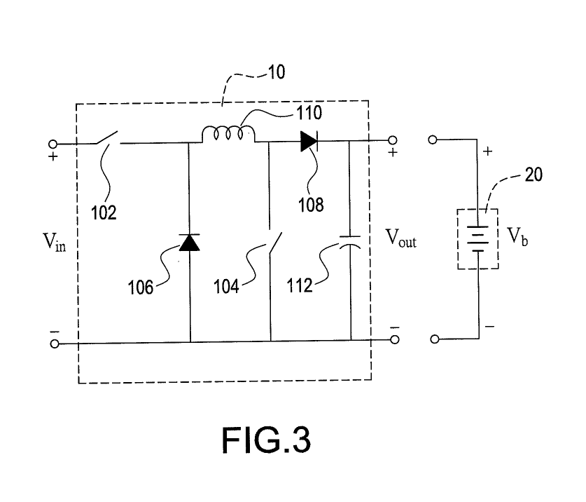

Reference is made to FIG. 3 which is a circuit diagram of an integrated buck-boost converter of a charging apparatus according to the present invention. The integrated buck-boost converter 10 of the charging apparatus (not shown) receives a DC input voltage Vin and converts a voltage level of the DC input voltage Vin to provide an output voltage Vout for charging a rechargeable battery 20. The integrated buck-boost converter 10 includes a first switch 102, a first diode 106, an inductor 110, a second switch 104, a second diode 108, and a capacitor 112.

The first switch 102 has a first terminal (not labeled) and a second terminal (labeled). The first diode 106 has an anode and a cathode, and the cathode of the first diode 106 is electrically connected to the second terminal of the first switch 102. The inductor 110 has a first terminal (not labeled) and a second terminal (labeled), and the first terminal of the inductor 110 is electrically connected to the second terminal of the first switch 102 and the cathode of the first diode 106. The second switch 104 has a first terminal (not labeled) and a second terminal (not labeled), and the first terminal of the second switch 104 is electrically connected to the second terminal of the inductor 110. The second diode 108 has an anode and a cathode, and the anode of the second diode 108 is electrically connected to the second terminal of the inductor 110 and the first terminal of the second switch 104. The capacitor 112 has a first terminal (not labeled) and a second terminal (not labeled), and the first terminal of the capacitor 112 is electrically connected to the cathode of the second diode 108 and the second terminal of capacitor 112 is electrically connected to the second terminal of the second switch 104 and the anode of the first diode 106.

The first terminal of the first switch 102 and the anode of the first diode 106 form a two-port input side of the integrated buck-boost converter 10 for receiving the input voltage Vin; and the first terminal of the capacitor 112 and the second terminal of the capacitor 112 form a two-port output side of the integrated buck-boost converter 10 for outputting the output voltage Vout to charge the rechargeable battery 20.

Therefore, the integrated buck-boost converter 10 can provide both a step-up operation and a step-down operation by controlling the first switch 102 and the second switch 104, thus accurately providing required voltage level of the output voltage Vout for charging the rechargeable battery 20.

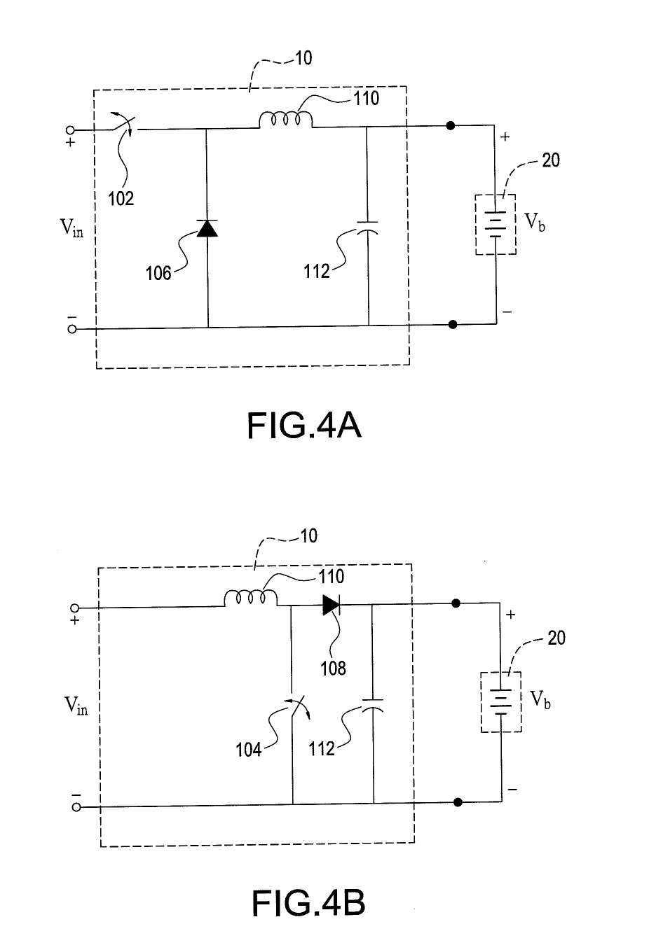

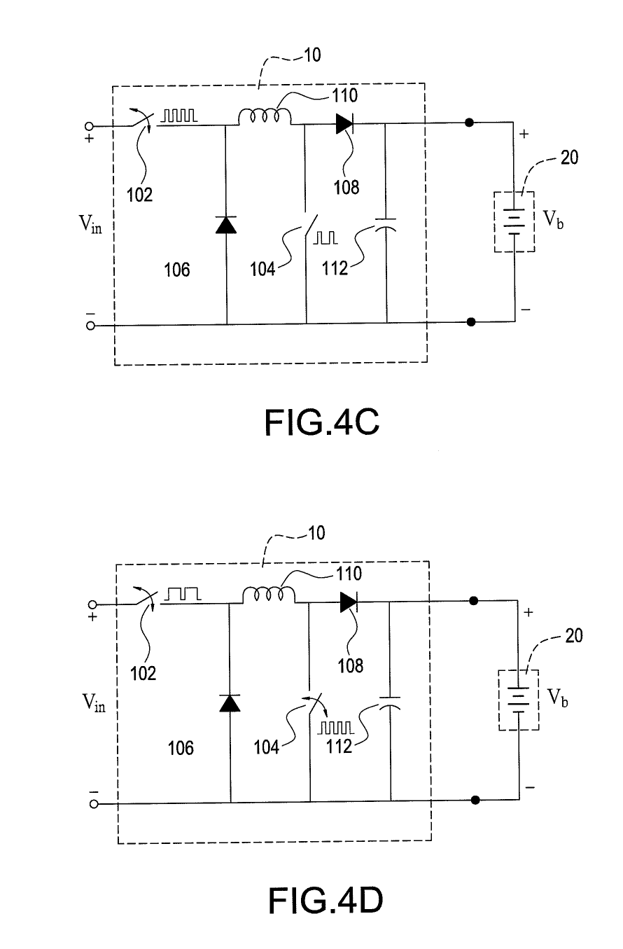

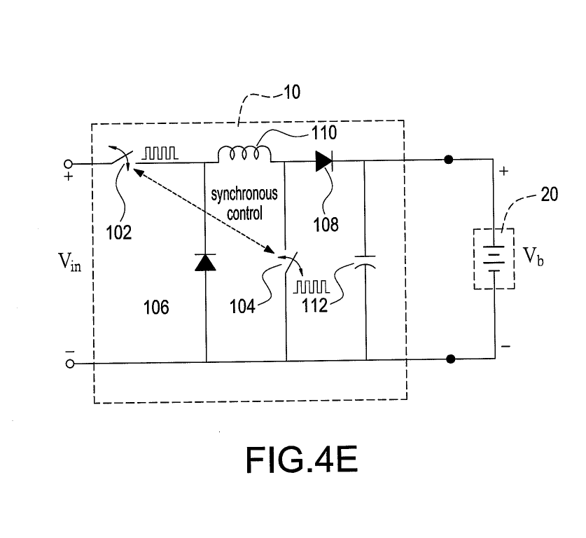

The detailed operation the integrated buck-boost converter 10 of the charging apparatus is described as follows. The first switch 102 is operated in a switching condition and the second switch 104 is operated in a full turned-off condition when the input voltage Vin is greater than a battery voltage Vb of the rechargeable battery 20, namely, a step-down operation of the integrated buck-boost converter 10 is executed. Hence, an equivalent circuit of the integrated buck-boost converter 10 is shown as FIG. 4A. Reference is made to FIG. 4A which is a circuit diagram of the integrated buck-boost converter which is operated in a large-voltage-difference step-down operation. The output voltage Vout of the integrated buck-boost converter 10 is decreased by controlling a duty cycle of the first switch 102, thus providing a required voltage level for normally charging the rechargeable battery 20. In particular, the duty cycle of the first switch 102 is controlled in a pulse-width modulation (PWM) scheme. When the rechargeable battery 20 needs to be charged, the external AC power source Vs is filtered and rectified into a DC voltage, namely, the input voltage Vin of the integrated buck-boost converter 10. If the input voltage Vin is greater than the battery voltage Vb of the rechargeable battery 20, the integrated buck-boost converter 10 acts as a buck converter for providing a step-down operation by controlling the first switch 102 and the second switch 104, thus obtaining the smaller output voltage Vout (relatively to the input voltage Vin) to meet the required voltage level of the battery voltage Vb. Hence, this prevents the rechargeable battery 20 from damage and even explosion because of the higher charging voltage. In particular, the above-mentioned high-voltage difference means that the input voltage Vin of the integrated buck-boost converter 10 exceeds the battery voltage Vb of the rechargeable battery 20 up to a certain voltage difference.

In addition, the first switch 102 is operated in a full turned-on condition or a maximum duty cycle condition and the second switch 104 is operated in a switching condition when the input voltage Vin is smaller than the battery voltage Vb of the rechargeable battery 20, namely, a step-up operation of the integrated buck-boost converter 10 is executed. Hence, an equivalent circuit of the integrated buck-boost converter 10 is shown as FIG. 4B. Reference is made to FIG. 4B which is a circuit diagram of the integrated buck-boost converter which is operated in a large-voltage-difference step-up operation. The output voltage Vout of the integrated buck-boost converter 10 is increased by controlling a duty cycle of the second switch 104, thus providing a required voltage level for normally charging the rechargeable battery 20. In particular, the duty cycle of the second switch 104 is controlled in a pulse-width modulation (PWM) scheme. When the rechargeable battery 20 needs to be charged, the external AC power source Vs is filtered and rectified into a DC voltage, namely, the input voltage Vin of the integrated buck-boost converter 10. If the input voltage Vin is smaller than the battery voltage Vb of the rechargeable battery 20, the integrated buck-boost converter 10 acts as a boost converter for providing a step-up operation by controlling the first switch 102 and the second switch 104, thus obtaining the greater output voltage Vout (relatively to the input voltage Vin) to meet the required voltage level of the battery voltage Vb. Hence, this prevents the rechargeable battery 20 from abnormal operation because of the lower charging voltage. In particular, the above-mentioned high-voltage difference means that the input voltage Vin of the integrated buck-boost converter 10 is smaller than the battery voltage Vb of the rechargeable battery 20 up to a certain voltage difference.

It follows from what has been said that the first switch 102 or the second switch 104 can be appropriately controlled to provide the step-up operation or the step-down operation according to a relationship between the input voltage Vin and the battery voltage Vb. Also, only one of the first switch 102 and the second switch 104 is operated in a switching condition whether the step-down operation or the step-up operation of the integrated buck-boost converter 10 is executed. That is, the first switch 102 is operated in a switching condition (also, the second switch 104 is operated in a full turned-off condition) when the step-down operation is executed. On the other hand, the second switch 104 is operated in a switching condition (also, the first switch 102 is operated in a full turned-on condition or a maximum duty cycle condition) when the step-up operation is executed. Hence, the difference between the prior art buck-boost converter and the integrated buck-boost converter 10 of the prevent invention is that the former has several switches being simultaneously switched. Hence, the integrated buck-boost converter 10 is provided to efficiently reduce the switching losses of the switches and significantly increase the overall conversion efficiency.

Especially to deserve to be mentioned, only one of the buck converter or the boost converter used for providing the required voltage level is not well done when the charging voltage is slightly greater or smaller than the battery voltage Vb, and more particularly to the unstable charging voltage due to ripple voltage of the input voltage Vin.

Accordingly, the integrated buck-boost converter 10 of the prevent invention provides three operation modes to simplify the prior art two-stage DC/DC converter structure and overcome the unstable charging voltage. The first mode is shown in FIG. 4C which is a circuit diagram of the integrated buck-boost converter which is operated in a small-voltage-difference operation according to a first embodiment of the present invention. The duty cycle of the first switch 102 can be controlled by a pulse-width modulation (PWM) technology and the duty cycle of the second switch 104 is fixed when the input voltage Vin is near to the battery voltage Vb, namely, an absolute value of voltage difference between the input voltage Vin and the battery voltage Vb is small. Hence, the integrated buck-boost converter 10 can accurately provide a required voltage level of the output voltage Vout for charging the rechargeable battery 20 through a feedback control via the first switch 102. In particular, the range of the low-voltage difference is set according to the practical application of the rechargeable battery 20.

The second mode is shown in FIG. 4D which is a circuit diagram of the integrated buck-boost converter which is operated in a small-voltage-difference operation according to a second embodiment of the present invention. The duty cycle of the second switch 104 can be controlled by a pulse-width modulation (PWM) technology and the duty cycle of the first switch 102 is fixed when the input voltage Vin is near to the battery voltage Vb, namely, an absolute value of voltage difference between the input voltage Vin and the battery voltage Vb is small. Hence, the integrated buck-boost converter 10 can accurately provide a required voltage level of the output voltage Vout for charging the rechargeable battery 20 through a feedback control via the second switch 104. In particular, the range of the low-voltage difference is set according to the practical application of the rechargeable battery 20.

The third mode is shown in FIG. 4E which is a circuit diagram of the integrated buck-boost converter which is operated in a small-voltage-difference operation according to a third embodiment of the present invention. The duty cycle of the first switch 102 and the duty cycle of the second switch 104 can be synchronously controlled by a pulse-width modulation (PWM) technology when the input voltage Vin is near to the battery voltage Vb, namely, an absolute value of voltage difference between the input voltage Vin and the battery voltage Vb is small. Hence, the integrated buck-boost converter 10 can accurately provide a required voltage level of the output voltage Vout for charging the rechargeable battery 20 through a feedback control via the first switch 102 and the second switch 104. In particular, the range of the low-voltage difference is set according to the practical application of the rechargeable battery 20.

In conclusion, the present invention has following advantages:

1. The used components of the integrated buck-boost converter are less than those of the prior art two-stage DC/DC converter, thus reducing costs of the used components;

2. The integrated buck-boost converter can is used to alternatively provide the step-up operation and the step-down operation according to the battery voltage of the rechargeable battery;

3. Only one of the first switch and the second switch is operated in a switching condition or the first switch and the second switch are synchronously controlled when the integrated buck-boost converter is operated in a step-down operation or step-up operation, thus efficiently reduce the switching losses of the switches and significantly increase the overall conversion efficiency; and

4. The integrated buck-boost converter can provide both a step-up operation and a step-down operation by controlling the switches, thus accurately providing required voltage level of the output voltage for charging the rechargeable battery. Hence, this prevents the rechargeable battery from damage and even explosion because of the higher charging voltage or prevents the rechargeable battery from abnormal operation because of the lower charging voltage.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An integrated buck-boost converter of a charging apparatus receiving a DC input voltage and converting a voltage level of the DC input voltage to provide an output voltage for charging a rechargeable battery; the integrated buck-boost converter comprising:
a first switch having a first terminal and a second terminal;
a first diode having an anode and a cathode, and the cathode of the first diode electrically connected to the second terminal of the first switch;
an inductor having a first terminal and a second terminal, and the first terminal of the inductor electrically connected to the second terminal of the first switch and the cathode of the first diode;
a second switch having a first terminal and a second terminal, and the first terminal of the second switch electrically connected to the second terminal of the inductor;
a second diode having an anode and a cathode, and the anode of the second diode electrically connected to the second terminal of the inductor and the first terminal of the second switch;
a capacitor having a first terminal and a second terminal, and the first terminal of the capacitor electrically connected to the cathode of the second diode and the second terminal of capacitor electrically connected to the second terminal of the second switch and the anode of the first diode;
wherein the first terminal of the first switch and the anode of the first diode form a two-port input side of the integrated buck-boost converter for receiving the input voltage; and the first terminal of the capacitor and the second terminal of the capacitor form a two-port output side of the integrated buck-boost converter for outputting the output voltage to charge the rechargeable battery;
whereby the integrated buck-boost converter can provide both a step-up operation and a step-down operation by controlling the first switch and the second switch, thus accurately providing required voltage level of the output voltage for charging the rechargeable battery.

2. The integrated buck-boost converter of claim 1, wherein the first switch is operated in a switching condition and the second switch is operated in a full turned-off condition when the input voltage is greater than the battery voltage of the rechargeable battery, thus decreasing the output voltage of the integrated buck-boost converter by controlling a duty cycle of the first switch to provide a required voltage level for normally charging the rechargeable battery.

3. The integrated buck-boost converter of claim 1, wherein the first switch is operated in a full turned-on condition or a maximum duty cycle condition and the second switch is operated in a switching condition when the input voltage is smaller than the battery voltage of the rechargeable battery, thus increasing the output voltage of the integrated buck-boost converter by controlling a duty cycle of the second switch to provide a required voltage level for normally charging the rechargeable battery.

4. The integrated buck-boost converter of claim 1, wherein the first switch is operated in a switching condition and the second switch is operated in a fixed duty cycle condition when the input voltage is near to the battery voltage of the rechargeable battery, thus decreasing the output voltage of the integrated buck-boost converter by controlling a duty cycle of the first switch to provide a required voltage level for normally charging the rechargeable battery.

5. The integrated buck-boost converter of claim 1, wherein the first switch is operated in a fixed duty cycle condition and the second switch is operated in a switching condition when the input voltage is near to the battery voltage of the rechargeable battery, thus increasing the output voltage of the integrated buck-boost converter by controlling a duty cycle of the second switch to provide a required voltage level for normally charging the rechargeable battery.

6. The integrated buck-boost converter of claim 1, wherein the first switch and the second switch are operated in a switching condition when the input voltage is near to the battery voltage of the rechargeable battery, thus providing a required voltage level for normally charging the rechargeable battery by synchronously controlling a duty cycle of the first switch and a duty cycle of the second switch.

7. The integrated buck-boost converter of claim 2, wherein the duty cycle of the first switch is controlled in a pulse-width modulation scheme.

8. The integrated buck-boost converter of claim 3, wherein the duty cycle of the second switch is controlled in a pulse-width modulation scheme.

9. The integrated buck-boost converter of claim 4, wherein the duty cycle of the first switch is controlled in a pulse-width modulation scheme.

10. The integrated buck-boost converter of claim 5, wherein the duty cycle of the second switch is controlled in a pulse-width modulation scheme.

11. The integrated buck-boost converter of claim 6, wherein the duty cycle of the first switch and the duty cycle of the second switch are controlled in a pulse-width modulation scheme.
